(19) United States
(12) Patent Application Publication
(10) Pub. No.: US 2007/0145653 A1
(43) Pub. Date: Jun. 28, 2007

(54) Air damper

(76) Inventors: Jan Toczycki, Chicago, IL (US); Owen J. McGarel, Naperville, IL (US); Jasmin Koc, Wuerzburg (DE)

Correspondence Address: ILLINOIS TOOL WORKS INC., 3600 WEST LAKE AVENUE, PATENT DEPARTMENT, GLENVIEW, IL, 60025, US

(21) Appl. No.: 11/526,805

(22) Filed: Sep. 25, 2006

Related U.S. Application Data
(60) Provisional application No. 60/750,481, filed on Dec. 15, 2005.

(51) Int. Cl. F16F 5/00

(52) U.S. Cl. 267/64.11

(57) ABSTRACT

An air damper includes a main housing having an interior wall defining an inner chamber, a piston disposed within the inner chamber, and an arch-shaped gasket member connected to the piston. The arch-shaped gasket member includes an annular rim that sealingly engages the interior wall of the housing.

### RELATED APPLICATIONS

This application relates to and claims priority benefits from U.S. Provisional Patent Application No. 60/750,481 entitled “Air Damper,” filed Dec. 15, 2005, which is hereby incorporated by reference in its entirety.

### FIELD OF THE INVENTION

Embodiments of the present invention generally relate to an air damper, and more particularly to an air damper that may be used in various automobile applications, such as with an automobile glove box.

### BACKGROUND OF THE INVENTION

FIG. 1 illustrates a side elevation view of a conventional air damper 10. The air damper 10 includes a tubular housing 12 having an inner chamber 14. A piston 16 is positioned within the inner chamber 14. The piston 16 includes a structure engaging end 18 outwardly extending from the inner chamber 14, and an end 20 within the inner chamber 14 of the housing 12. The structure engaging end 18 is configured to attach to another structure (not shown), such as a hinge of an automobile glove box, in order to dampen movement of an attached glove box door. A spring 19 may be positioned around the piston 16 to provide an additional resistive force.

A gasket clip 22 is secured to the end 20 of the piston 16 within the inner chamber 14 of the housing 12. The gasket clip 22 may snap onto the end 20, and is configured to retain a gasket 24. The gasket 24 is configured to secure around an outer circumference of a gasket retaining area 26 of the gasket clip 22. The gasket 24 is ring-shaped and is configured to sealingly engage an inner surface 28 of the housing 12 and the gasket retaining area 26 of the gasket clip 22. As shown in FIG. 1, the gasket 24, not the gasket clip 22, sealingly engages against the inner surface 28 of the housing 12.

Although not clearly shown, the gasket clip 22 also includes a small groove or aperture extending through the gasket clip 22. Typically, the groove extends from the spring piston 16 to a variable chamber 29. As the piston 16 moves through directions denoted by arrow A, the variable chamber 29 increases or decreases, depending on the direction the piston 16 moves. The groove allows fluid, such as air, to travel between the variable chamber 29 and the rest of the inner chamber 14 in order to allow movement of the piston 16. Without displacing some fluid, or controlling leakage, the piston 16 would be difficult, if not impossible, to move within the inner chamber 14 of the housing 12.

The gasket 24 is coated with a suitable material to enable smooth cooperation between the gasket 24 and the inner surface 28 of the housing 12. Typically, the gasket 24 is formed of an ethylene propylene diene monomer (EPDM). The EPDM gasket 23 is reliable and effective for various applications. As new technologies arise, however, the current air damper 10 may be less than completely effective. For example, over time, the coating on the gasket 24 may wear off, thereby adversely affecting the overall operation of the damper. When the coating of the gasket 24 wears off, the force required to open and close a door attached to the damper increases. Additionally, EPDM is a relatively soft material and is susceptible to deformation. When the gasket 24 deforms, the aperture may be constricted or blocked, thereby restricting movement of the piston 16 through the inner chamber 14. Further, the gasket 24 may dislodge from the gasket clip 22, thereby rendering the air damper 10 inoperable.

Additionally, the coating process is very sensitive. At present there are very few suppliers that are capable of coating air dampers properly.

Thus, a need exists for a more resilient and dependable air damper. Further, a need exists for an air damper that provides constant and even resistance over time and increased temperatures.

### SUMMARY OF THE INVENTION

Certain embodiments of the present invention provide an air damper that includes a main housing having an interior wall defining an inner chamber, a piston disposed within the inner chamber, and a gasket member connected to said piston. The gasket member may be secured to the piston through an adhesive, such as epoxy, and/or it may snapably engage the piston. Optionally, the gasket member may be an integral part of the piston.

The gasket member may include an annular rim that sealingly engages the interior wall of the piston housing. The annular rim may include an outer wall or surface connected to a central column by a rounded arch, wherein a gap is defined between the outer wall, the rounded arch, and the central column.

The air damper may also include an elastomeric or thermoplastoelastomeric support, such as an O-ring disposed within said gap. Additionally, at least one of the main housing and the gasket member may include at least one fluid aperture, such as an air passage or groove.

The gasket member may be a gasket cap secured to the piston. Optionally, the gasket member may include an annular gasket secured around a portion of a gasket clip.

Certain embodiments of the present invention provide a gasket member for use in an air damper. The gasket member may include a main body including an annular rim having an outer wall or surface integrally connected to a central column through a rounded arch, wherein a gap is defined between the outer wall, the rounded arch, and the central column. The outer wall of the annular rim is configured to sealingly engage an interior wall of a piston housing.

### BRIEF DESCRIPTION OF SEVERAL VIEWS OF THE DRAWINGS

FIG. 1 illustrates a side elevation view of a conventional air damper.

FIG. 2 illustrates a top plan view of a gasket cap according to an embodiment of the present invention.

FIG. 3 illustrates a cross-sectional view of a gasket cap through line 3-3 of FIG. 2.

FIG. 4 illustrates a side elevation view of an air damper according to an embodiment of the present invention.

FIG. 5 illustrates a side elevation view of an air damper according to an embodiment of the present invention.

FIG. 6 illustrates a top plan view of a gasket clip according to an embodiment of the present invention.

FIG. 7 illustrates a cross-sectional view of a gasket clip through line 7-7 of FIG. 6.

FIG. 8 illustrates an isometric view of a piston and gasket cap according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

FIG. 2 illustrates a top plan view of a gasket cap (or piston tip) 30 according to an embodiment of the present invention. The gasket cap 30 includes a main cylindrical body or column 32 integrally connected to a circumferential ledge 34 extending around the main cylindrical body 32. The gasket cap 30 may or may not include an aperture (not shown) configured to control fluid leakage.

The gasket cap 30 may be formed of a polyolefin, such as a polyolefin based resin, or thermoplast material. In general, the polyolefin materials may contain oil or other fillers. The resin may be, for example, from the group of materials further classified as polyethylene or polypropylene. Such materials are further subdivided into low density polyethylene (LDPE), linear low density polyethylene (LLDPE), medium density polyethylene (MDPE), high density polyethylene (HDPE), high and ultrahigh molecular weight polyethylene (HMWPE and UHMWPE), homopolymer polypropylene, random copolymer polypropylene, and impact copolymer polypropylene (PP). A number of metallocene catalyst based olefin materials may also be used. Such materials enable the gasket cap 30 to sealingly engage an inner wall of a housing, without being coated with an additional material.

FIG. 3 illustrates a cross-sectional view of the gasket cap 30 through line 3-3 of FIG. 2. As shown in FIG. 3, a central cavity 36 passes through the central axis x of the main cylindrical body 32. An annular rim 38 extends from an edge 40 of the ledge 34 toward a plane y in which a base 42 of the cylindrical body 32 resides. While the annular rim 38 does not reach the plane y, as shown in FIG. 3, the annular rim 38 may, alternatively, extend to, or past the plane y.

The annular rim 38 includes an outer surface 44 integrally connected to a ramped inner surface 46. The outer surface 44 and the ramped inner surface 46 form a wall or flap. The ramped inner surface 46 integrally connects to an underside 48 of the ledge 34, thereby defining a gap 50 between the inner surface 46 and an outer surface 51 of the main cylindrical body 32.

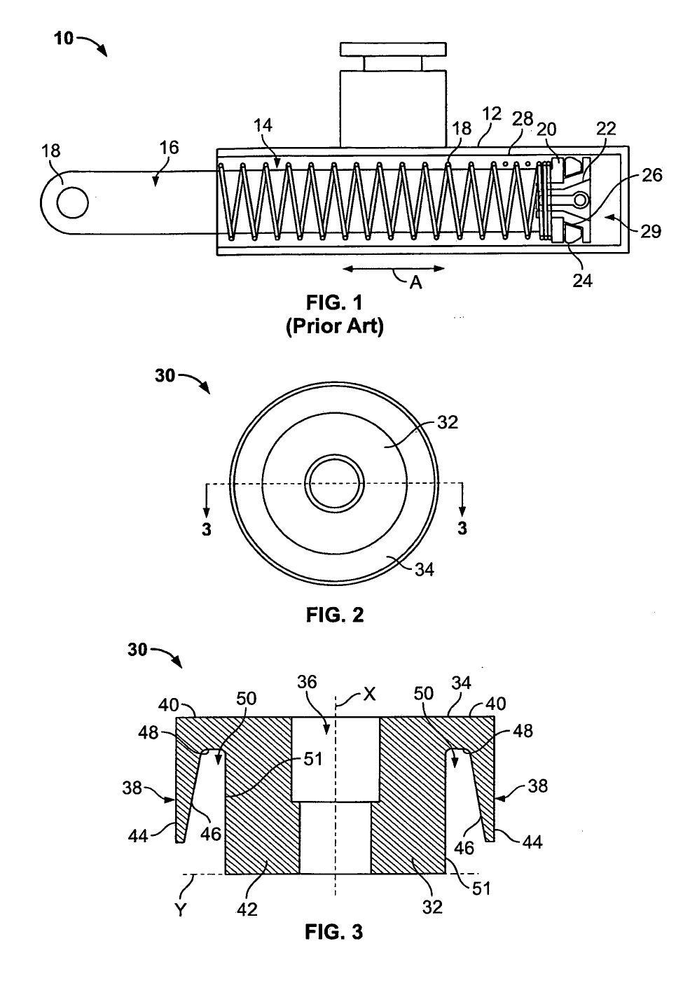

The outer surface 44 of the annular rim 38 is configured to sealingly engage an inner surface of a damper housing (not shown in FIG. 3). Thus, the gasket cap 30 does not need to include a separate and distinct gasket, as shown in FIG. 1. Instead, the gasket cap 30 maintains constant and even sealing engagement with an inner wall of a housing, and is not susceptible to a separate sealing component, such as a separate gasket, dislodging therefrom. While no additional gasket is required, the gasket cap 30 may, alternatively, retain an additional gasket (not shown).

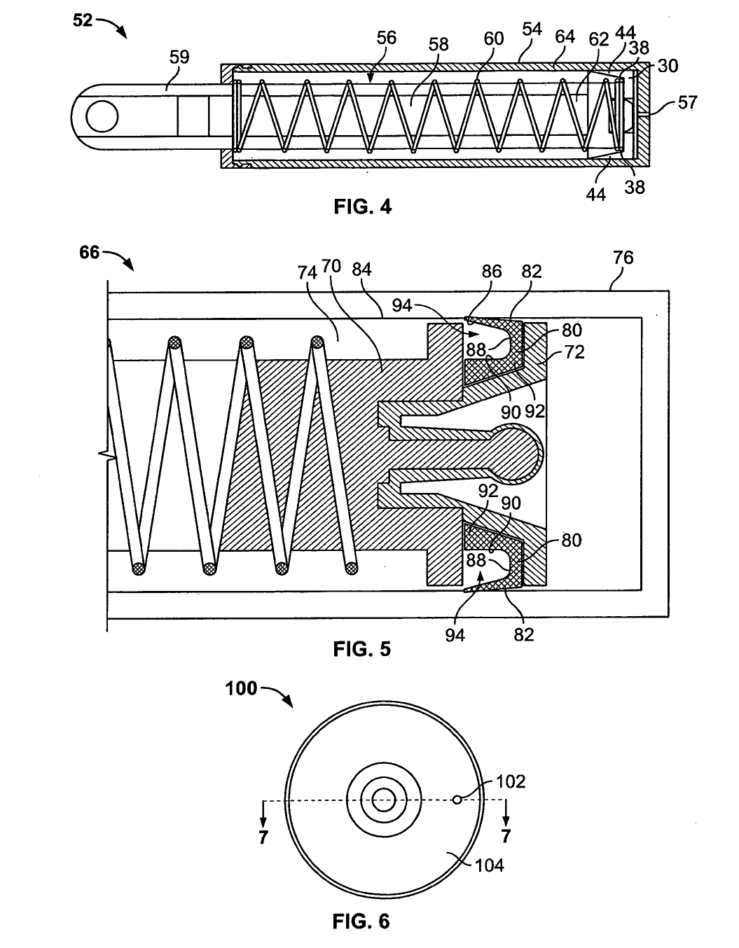

FIG. 4 illustrates a side elevation view of an air damper 52 according to an embodiment of the present invention. The air damper 52 includes a housing 54 having an inner chamber 56. A fluid aperture 57 is formed through a closed end of the housing 54. The fluid aperture 57 is located in center of the damper 52. Alternatively, the damper 52 may include more than one fluid aperture 57. The fluid aperture 57 is configured to control fluid leakage. Thus, the gasket cap 30 does not need an aperture. A piston 58 is positioned within the inner chamber 56, such that a structure engaging end 59 of the piston 58 outwardly extends from the inner chamber 56. A spring 60 may be positioned around the piston 58.

The gasket cap 30 is secured to the end 62 of the piston 58 within the housing 54. For example, the gasket cap 30 may be attached to the piston 58 through various mechanisms, such as tabs, slots, pins, latches, epoxy, and the like. FIG. 8, for example, illustrates a gasket cap 30 that is configured to secure to a piston 58 by way of a pin 130 securely fastening into a reciprocal retaining passage 132. Optionally, the gasket cap 30 and the piston 58 may be integrally manufactured as a single piece. As shown in FIG. 4, the outer surface 44 of the annular rim 38 sealingly engages an inner surface 64 of the housing 54. As the piston 58 and the gasket cap 30 move through the inner chamber 56 along a longitudinal axis of the housing 54, the outer surface 44 of the annular rim 38 continues to sealingly engage the inner surface 64 of the housing 54.

In operation, as the piston 58 is drawn out of the housing 54, the sealing contact between the gasket cap 30 and the inner surface 64 of the housing 54, in combination with the aperture 57 formed in the housing 54, may produce a partial vacuum or increased pressure within the air damper 52. The resulting partial vacuum or increased pressure restricts or dampens the speed at which the piston 58 is drawn out of the housing 54. The restricted or dampened movement of the piston 58 may be advantageously used in applications in which slower movement is desired. For example, a person may not wish a glove compartment door to abruptly swing open.

Optionally, the aperture 57 may be a variable aperture. For example, an actuatable shutter may be positioned around, in, or over the aperture 57. Changing the size of the aperture 57 changes the operating time of the air damper 52. For example, a large aperture causes the piston 58 to move through the inner chamber 56 quickly, while a small aperture causes the piston 58 to move through the inner chamber 56 slowly.

FIG. 5 illustrates a side elevation view of an air damper 66 according to an embodiment of the present invention. A piston 70 secured to a gasket clip 72 is positioned within the inner chamber 74 of a damper housing 76. The gasket clip 72 may be similar to the gasket clip 22 shown in FIG. 1. However, instead of using a conventional gasket, the air damper 66 includes a modified U-shaped gasket 80 that is retained by the gasket clip 22. The gasket 80 includes an outer surface 82 that sealingly engages the inner surface 84 of the housing 76. The outer surface 82 of the gasket 80 is integrally connected to a ramped inner surface 86 that, in turn, integrally connects to a rounded arch 88. The rounded arch 88, in turn, connects to an outer surface 90 of a clip retaining wall 92. As shown in FIG. 5, a U, or arch shaped cavity 94 is defined between the ramped inner surface 86, the rounded arch 88, and the outer surface 90 of the clip retaining wall 92. A conventional gasket clip, such as the gasket clip 22 shown in FIG. 1, may be retrofitted by using the gasket 80, instead of a conventional gasket.

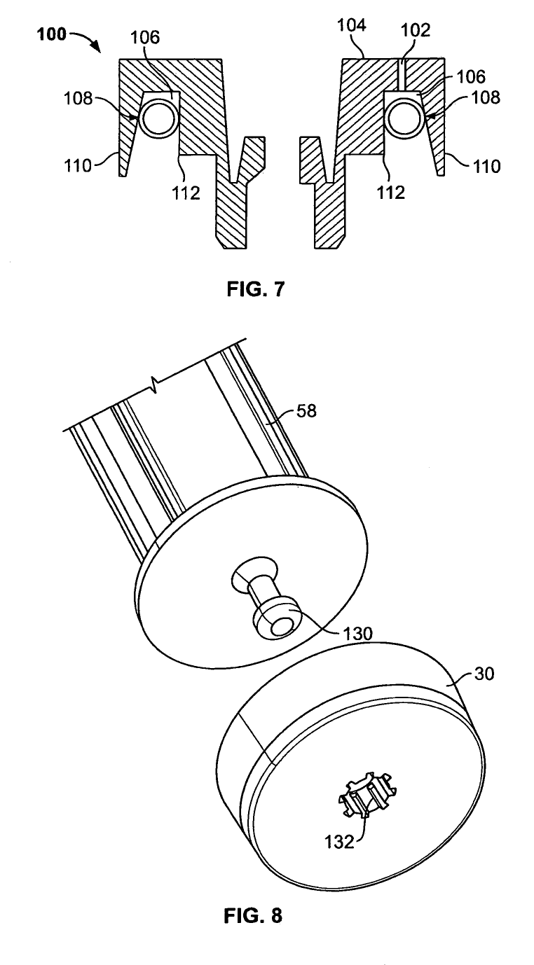

FIG. 6 illustrates a top plan view of a gasket cap 100 according to an embodiment of the present invention. FIG. 7 illustrates a cross-sectional view of the gasket cap 100 through line 7-7 of FIG. 6. Referring to FIGS. 6 and 7, the gasket cap 100 is similar to the gasket cap 30 shown in FIGS. 2-4. The gasket cap 100, however, includes a fluid passage 102 formed through the ledge 104. Thus, fluid may pass into and through the ledge 104, into the gap 106, and vice versa. Additionally, as shown in FIG. 7, a separate and distinct elastomeric or thermoplastoelastomeric support, such as an O-ring 108, may be positioned in the gap 106. The O-ring 108 may be compressively sandwiched between the annular rim 110 and the main body 112.

The O-ring 108 provides additional strength to the gasket cap 100. That is, the O-ring 108 controls deflection of the annular rim 110 in order to prevent the annular rim 108 from weakening over time. Moreover, the O-ring 108 exerts an outward force into the annular rim 108, thereby ensuring that the annular rim 108 is in sealing contact with an inner surface (not shown in FIGS. 6 and 7) of the housing (not shown in FIGS. 6 and 7). Grooves (not shown) may exist between the O-ring 108 and the surface of the gasket cap 100. That is, grooves may be formed in either the O-ring 108 or the gasket cap 100. The grooves provide an unblocked air passage between the O-ring 108 and the gasket cap 100.

Referring to FIGS. 2-7, the gasket cap 30, the gasket 80, and the gasket cap 100 may be formed of high density polyethylene (HDPE), thermoplast material, or various other materials noted above. It has been found that HDPE performs better than conventional coated gaskets. In particular, it has been discovered that the embodiments of the present invention may be formed of acetal based materials (e.g., a homopolymer or copolymer acetal material) in order to provide an air damper that operates evenly, smoothly, and reliably. The acetal based material may include fillers and/or lubricants. Embodiments of the present invention may also be formed of nylon based materials, polycarbonate, or polycarbonate blends. Overall, embodiments of the present invention are formed from stronger materials than EPDM.

As shown and described above, embodiments of the present invention provide a resilient and dependable air damper. Further, embodiments of the present invention provide an air damper that provides a constant operational force over time due to the fact that the gasket cap (or gasket) maintains constant and even sealing contact with the inner wall of the damper housing.

While various spatial terms, such as upper, lower, mid, lateral, horizontal, vertical, and the like may used to describe portions of the air damper, gasket cap, gasket clip, etc., it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. An air damper comprising:
a main housing having an interior wall defining an inner chamber;
a piston disposed within said inner chamber; and
a gasket member connected to said piston, said gasket member comprising an annular rim connected to a central column through an arch, wherein said annular rim sealingly engages said interior wall.

2. The air damper of claim 1, wherein said gasket member is a gasket cap secured to said piston.

3. The air damper of claim 1, wherein said piston is integrally formed with said gasket member.

4. The air damper of claim 1, further comprising a gasket clip, and wherein said gasket member comprises an annular gasket secured around a portion of said gasket clip.

5. The air damper of claim 1, wherein said gasket member is formed of at least one of polyethylene and polypropylene.

6. The air damper of claim 1, wherein said gasket member is formed of at least one of low density polyethylene (LDPE), linear low density polyethylene (LLDPE), medium density polyethylene (MDPE), high density polyethylene (HDPE), high and ultrahigh molecular weight polyethylene (HMWPE and UHMWPE), homopolymer polypropylene, random copolymer polypropylene, and impact copolymer polypropylene (PP).

7. The air damper of claim 1, wherein at least one of said main housing and said gasket member further comprises at least one fluid aperture.

8. The air damper of claim 1, wherein said annular rim comprises an outer wall connected to a central column by a rounded arch, wherein a gap is defined between said outer wall, said rounded arch, and said central column.

9. The air damper of claim 1, further comprising an elastomeric support disposed within said gap.

10. A gasket member for use in an air damper, said gasket member comprising:
a main body comprising an annular rim having an outer wall integrally connected to a central column through a rounded arch, wherein a gap is defined between said outer wall, said rounded arch, and said central column, said outer wall of said annular rim configured to sealingly engage an interior wall of a piston housing.

11. The gasket member of claim 10, wherein said main body is a gasket cap secured to a piston.

12. The gasket member of claim 10, wherein main body is integrally formed with a piston.

13. The gasket member of claim 10, further comprising a gasket clip, wherein said main body is an annular gasket secured around a portion of said gasket clip.

14. The gasket member of claim 10, wherein said main body is formed of at least one of polyethylene and polypropylene.

15. The gasket member of claim 10, wherein said main body is formed of at least one of low density polyethylene (LDPE), linear low density polyethylene (LLDPE), medium density polyethylene (MDPE), high density polyethylene (HDPE), high and ultrahigh molecular weight polyethylene (HMWPE and UHMWPE), homopolymer polypropylene, random copolymer polypropylene, and impact copolymer polypropylene (PP).

16. The gasket member of claim 10, wherein said main body further comprises at least one fluid aperture.

17. The gasket member of claim 10, further comprising an elastomeric or thermoplastoelastimeric support disposed within said gap.

18. An air damper comprising:
a main housing having an interior wall defining an inner chamber;
a piston disposed within said inner chamber;
a gasket member connected to said piston, said gasket member being formed of at least one of polyethylene and polypropylene and comprising an annular rim that sealingly engages said interior wall, said annular rim comprising an outer wall connected to a central column by a rounded arch, wherein a gap is defined between said outer wall, said rounded arch, and said central column; and
at least one of an elastomeric and thermoplastoelastomeric support disposed within said gap,
wherein at least one of said main housing and said gasket member further comprises at least one fluid aperture.

19. The air damper of claim 18, wherein said gasket member comprises a gasket cap secured to said piston.

20. The air damper of claim 18, wherein said gasket member comprises an annular gasket secured around a portion of a gasket clip.
